(19) United States
(12) Patent Application Publication
(10) Pub. No.: US 2012/0298478 A1
(43) Pub. Date: Nov. 29, 2012

(54) SEED TENDER

(76) Inventor: Henry Friesen, Winkler (CA)

(21) Appl. No.: 13/116,238

(22) Filed: May 26, 2011

(51) Int. Cl. B65G 41/02; B65G 15/26; B65G 15/24

(52) U.S. Cl. 198/311

(57) ABSTRACT

A seed tender is formed by a container with five compartments arranged in a row for mounting on a conventional trailer frame with a conveyor belt underneath discharge openings of the compartments for transporting the material to a rear where there is provided a discharge conveyor for transporting the material to a seeder. The discharge belt conveyor has a rectangular support frame and four sections which retract into the frame to stand upwardly along the rear in the retracted position. A mounting assembly provides a first swivel support for providing pivotal movement side to side of the support frame about a generally upstanding axis and a second swivel support for providing pivotal movement up and down of the support frame about a generally horizontal axis. The belt folds in the retracted position when driven by a chain retraction drive arrangement for driving extension and retraction of the conveyor belt support sections.

This invention relates to a seed tender which includes a discharge arrangement for transporting the material from the transport compartments of a container to discharge location, typically a seeder in the field.

### SUMMARY OF THE INVENTION

According to one aspect of the invention there is provided a seed tender comprising:

a container for mounting on a ground transportation vehicle;

the container having a plurality of separate compartments at separate locations along the length of the container, each compartment having a bottom discharge opening with a discharge control mechanism for allowing discharge of material when required;

a conveyor belt extending along the container underneath the discharge openings for receiving the material therefrom and transporting the material to a rear of the container;

and a discharge conveyor for receiving the material from a rear end of the conveyor belt and for conveying the material to a selected location beyond the rear of the container, the discharge conveyor comprising:
a support frame;
a mounting assembly for mounting the support frame on the container and providing a first swivel support for providing pivotal movement side to side of the support frame about a generally upstanding axis and a second swivel support for providing pivotal movement up and down of the support frame about a generally horizontal axis;
a plurality of conveyor belt support sections each having one or more support rollers for guiding the belt;
the conveyor belt support sections being mounted on the frame such that they can be telescoped from a retracted position in which the conveyor belt support sections overlie one another to an extended position with which the conveyor belt support sections are arranged in an extended row;
a belt arranged to fold in the retracted position and to be unfolded and extended in the extended position such that the belt extends along the extended row to transport material to an upper end of the extended row;
and a retraction drive arrangement for driving extension and retraction of the conveyor belt support sections.

Preferably there are at least three sections and more preferably four sections so that the reduced length when retracted is able to stand vertically upwardly along the rear of the container without reaching significantly higher than the container and the length when extended is sufficient to reach out to a seeded hopper.

Preferably the outer sections retract inwardly on top of each inner section to form a stack of the sections.

Preferably the frame of the innermost section is substantially rectangular with the outer sections stacked on top of one another in a row within the frame.

Preferably the mounting assembly includes a pair of depending side arms each arranged on a respective side of the rectangular frame and each coupled to the respective side of the frame to provide the second swivel support about the horizontal axis.

Preferably the mounting assembly includes a support bracket for attachment to the container, the support bracket carrying a central hub attached to the side arms which provides a swivel about the upright axis.

Preferably a first section is mounted in fixed position within the rectangular frame and each of the further sections includes a respective sub-frame which slides inside the frame so that each sub-frame slides inside a next adjacent sub-frame on top of the next adjacent subframe so as to form a stack within the frame.

Preferably each of the frames and the sub-frames is generally rectangular in cross-section and includes parallel side walls each of which slides into the next adjacent subframe on a track.

Preferably each or the frame and the sub-frames has a cover panel over the belt which slides underneath the cover of the next adjacent section.

Preferably there is provided a hopper at the bottom of the discharge conveyor and carried on the frame defining walls which converge the material from the conveyor belt.

Preferably the conveyor belt has a rear end thereof which is at a fixed relative to the container so that there is no need for adjustment of the position of the conveyor and there is provided a discharge nozzle or chute at the end of the conveyor belt which has walls arranged to direct material onto the bottom of the discharge conveyor within the hopper, the nozzle being pivotally adjustable in a direction longitudinally of the discharge conveyor so as to take into account changes in angle of the discharge conveyor.

Preferably the single belt is driven by a drive roller at the bottom end of the conveyor with the belt wrapped around a cylindrical surface of the drive roller and the drive roller has a hydraulic motor which is mounted within the cylindrical surface.

Preferably the retraction drive arrangement comprises a chain extending in serpentine manner around the sections and driven along its length to retract each section relative to the next.

Preferably the container has a base arranged to sit on a frame of a separate trailer and the mounting assembly is arranged to mount the discharge conveyor on the container separate from the trailer so that the whole assembly can be carried on a transport trailer of the type used for transporting containers.

According to a second aspect of the invention there is provided a seed tender comprising:

a container for mounting on a ground transportation vehicle;

the container having a plurality of separate compartments at separate locations along the length of the container, each compartment having a bottom discharge opening with a discharge control mechanism for allowing discharge of material when required;

a conveyor belt extending along the container underneath the discharge openings for receiving the material therefrom and transporting the material to a rear of the container;

and a discharge conveyor for receiving the material from a rear end of the conveyor belt and for conveying the material to a selected location beyond the rear of the container, the discharge conveyor comprising a belt and a plurality of guide rollers;

wherein the belt is driven by a drive roller at one end of the conveyor with the belt wrapped around a cylindrical surface of the drive roller and wherein the drive roller has a hydraulic motor which mounted within the cylindrical surface.

### BRIEF DESCRIPTION OF THE DRAWINGS

One embodiment of the invention will now be described in conjunction with the accompanying drawings in which:

FIG. 1 is a side elevational view of the seed tender according to the invention mounted on a trailer.

FIG. 2 is an isometric view of the discharge conveyor of the seed tender of FIG. 1 shown in the extended position.

FIG. 3 is a side elevational view of the discharge conveyor and mounting assembly of the seed tender of FIG. 1 shown in the retracted position.

FIG. 4 is an isometric view of the lower end only of the discharge conveyor and mounting assembly of the seed tender of FIG. 1.

FIG. 5 is a side elevational view on an enlarged scale of the mounting assembly of FIG. 3.

FIG. 6 is a top plan view on an enlarged scale of the mounting assembly of FIG. 3.

FIG. 7 is a side elevational view of the discharge conveyor of the seed tender of FIG. 1 shown in the extended position.

FIG. 8 is a side elevational view of the discharge conveyor of the seed tender of FIG. 1 shown in the retracted position.

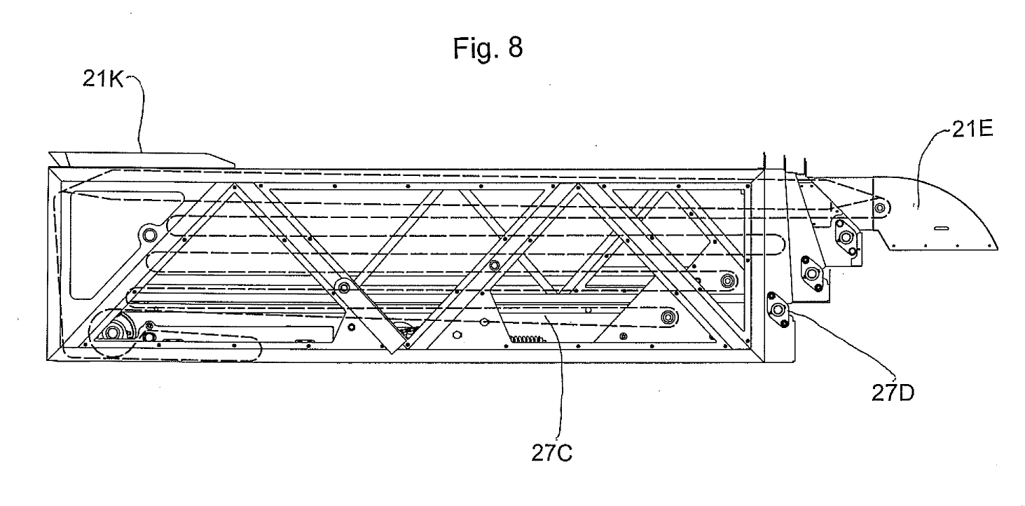

FIG. 9 is a side elevational view of the discharge conveyor of the seed tender of FIG. 1 showing the discharge chute from the conveyor belt and the hopper of the discharge conveyor.

FIG. 10 is a side elevational view of the discharge conveyor of the seed tender of FIG. 1 showing the belt drive.

FIG. 11 is an isometric view of the belt drive of FIG. 10

FIG. 12 is a side elevational view of the discharge conveyor showing the chain driven retraction and extension system in the retracted position.

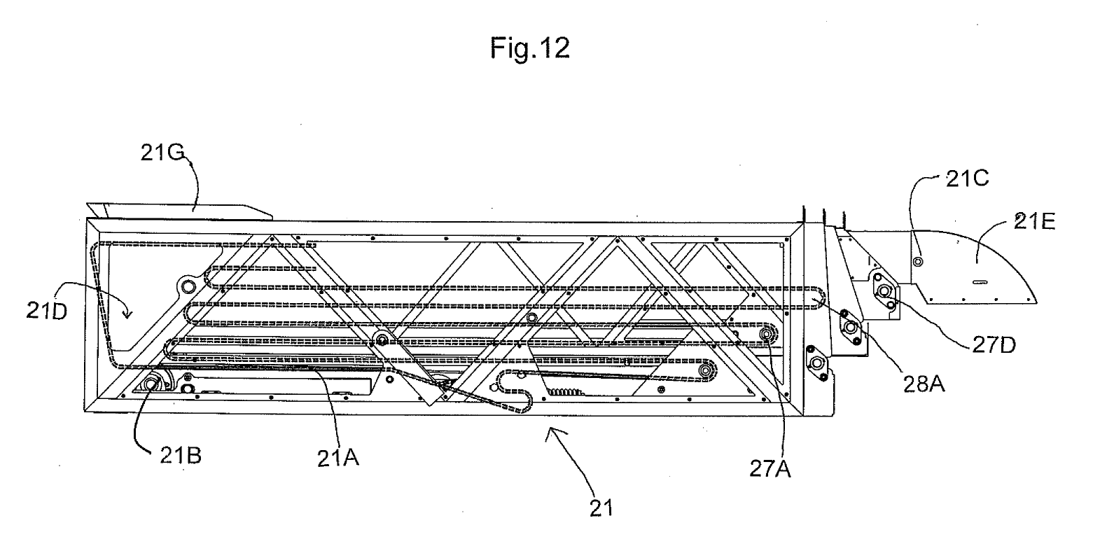

FIG. 13 is a side elevational view of the discharge conveyor showing the chain driven retraction and extension system in the extended position.

FIG. 14 is an isometric view of the chain drive to the retraction and extension system of FIG. 12.

In the drawings like characters of reference indicate corresponding parts in the different figures.

### DETAILED DESCRIPTION

The seed tender 10 shown in the Figures comprises a container 11 formed of five compartments arranged end to end to form a complete container with side walls 12, a front end wall 13 and a rear end wall 14. The container is shaped and arranged to sit on a conventional trailer of the type deigned to transport shipping containers so that the base of the container sits on a longitudinal frame of the trailer with discharge openings of the compartments arranged in a row between the frame beams of the trailer.

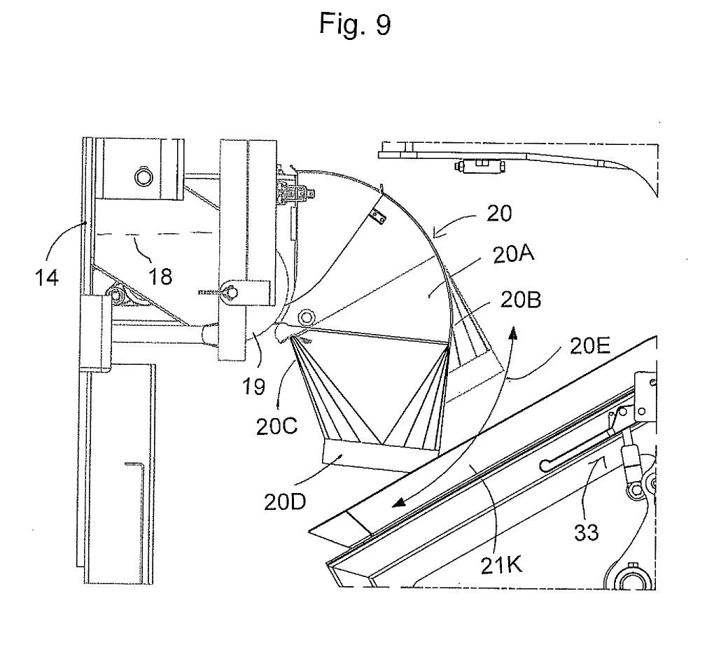

Thus each compartment 15 has a bottom discharge opening 16 with a discharge control mechanism 17 for allowing discharge of material when required. A conveyor belt 18 extends along the container underneath the discharge openings for receiving the material and transporting the material to the rear wall 14 of the container 11 where the material is discharged off a rear roller 19 of the conveyor belt 18. This is best shown in FIG. 9 where it can be seen that the belt 18 discharges into a chute 20 which controls the discharge of the material from the belt. The rear end of the belt at the roller 19 is at a fixed position relative to the container. The discharge nozzle or chute 20 at the end of the conveyor belt has side walls 20A, a front wall 20B walls and a rear wall 20C arranged to direct material to a bottom discharge mouth 20D which controls the feed of material downwardly to prevent release of material to the ground. The chute discharges through the mouth 20D downwardly with the position of the nozzle being pivotally adjustable in a direction longitudinally of the conveyor belt 18 as indicated at 20E.

The seed tender further includes a discharge conveyor 21 for receiving the material from a rear end of the conveyor belt 18 and for conveying the material to a selected location beyond the rear of the container. The discharge conveyor includes a rectangular support frame 22 which receives and contains the parts of the discharge conveyor and a mounting assembly 23 for mounting the support frame 22 on the container 11.

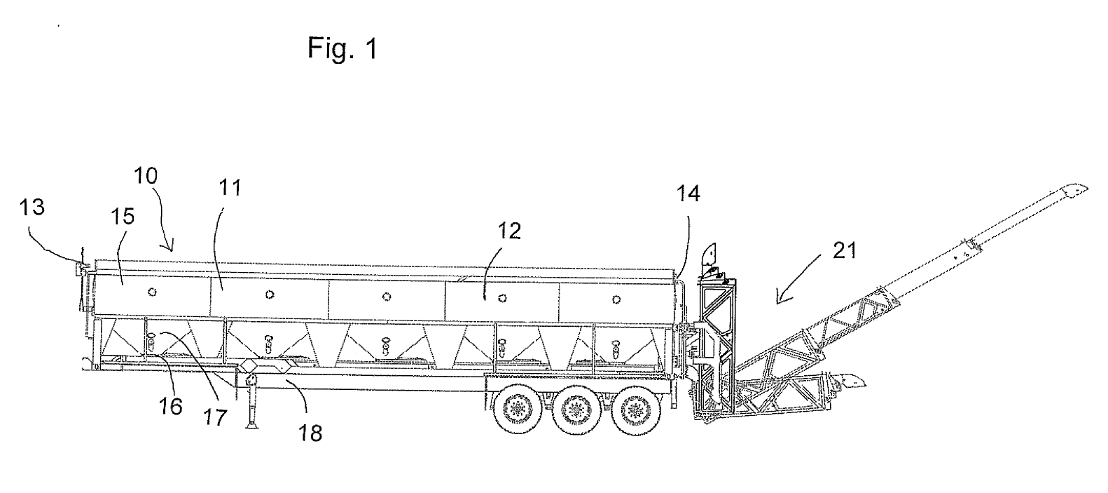

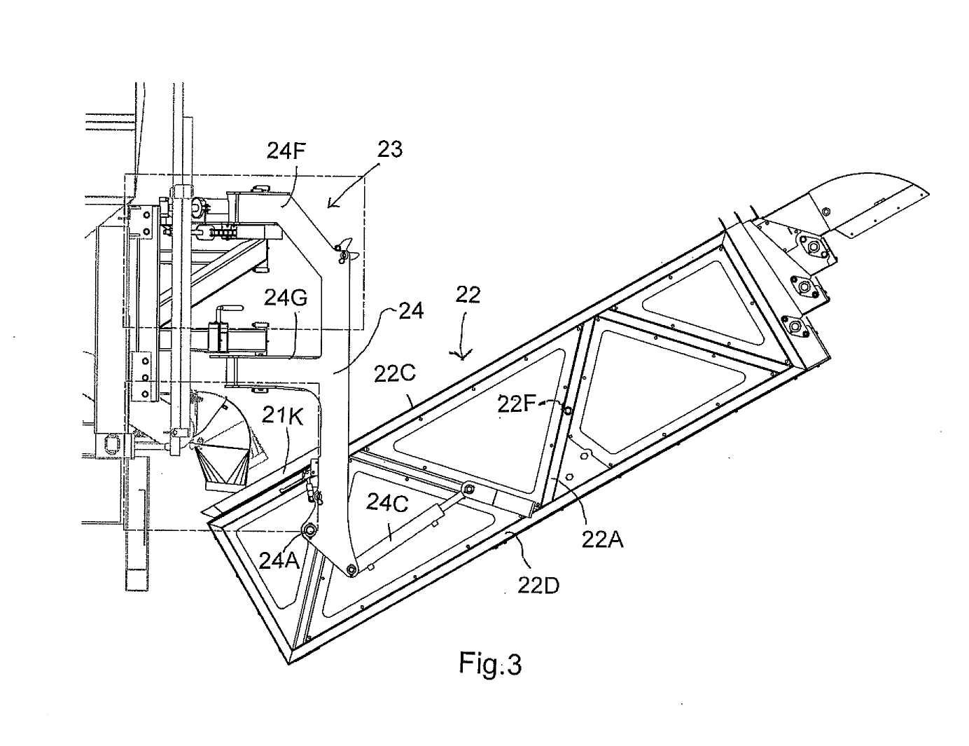

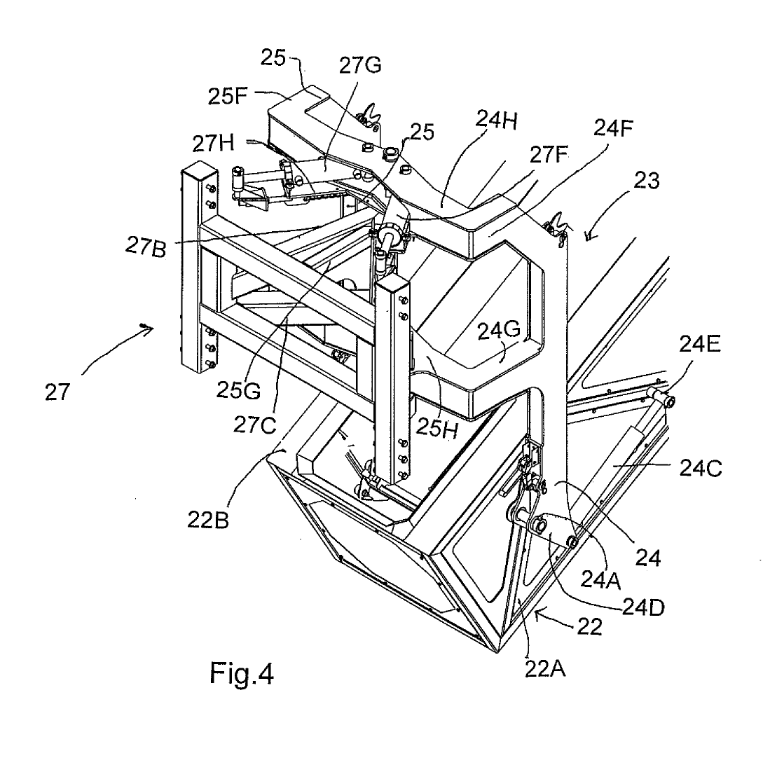

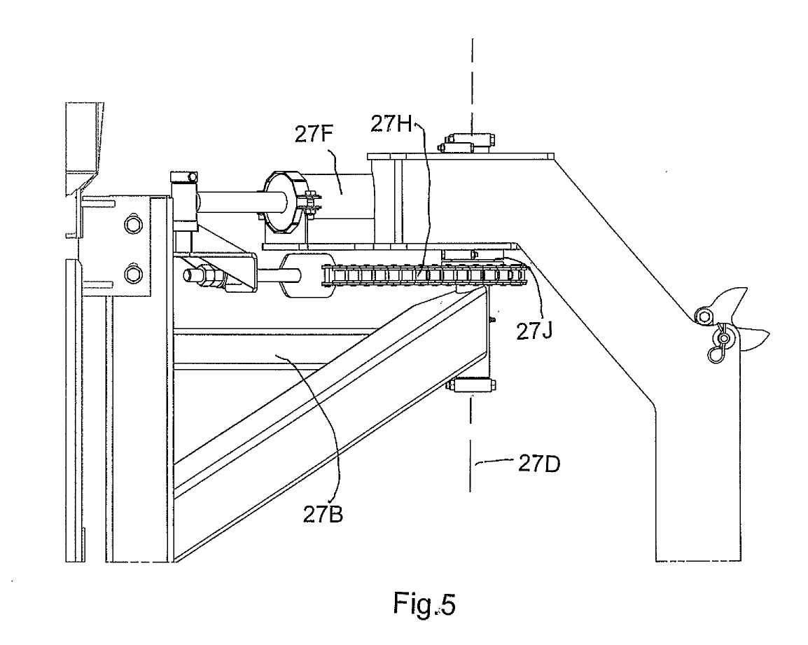

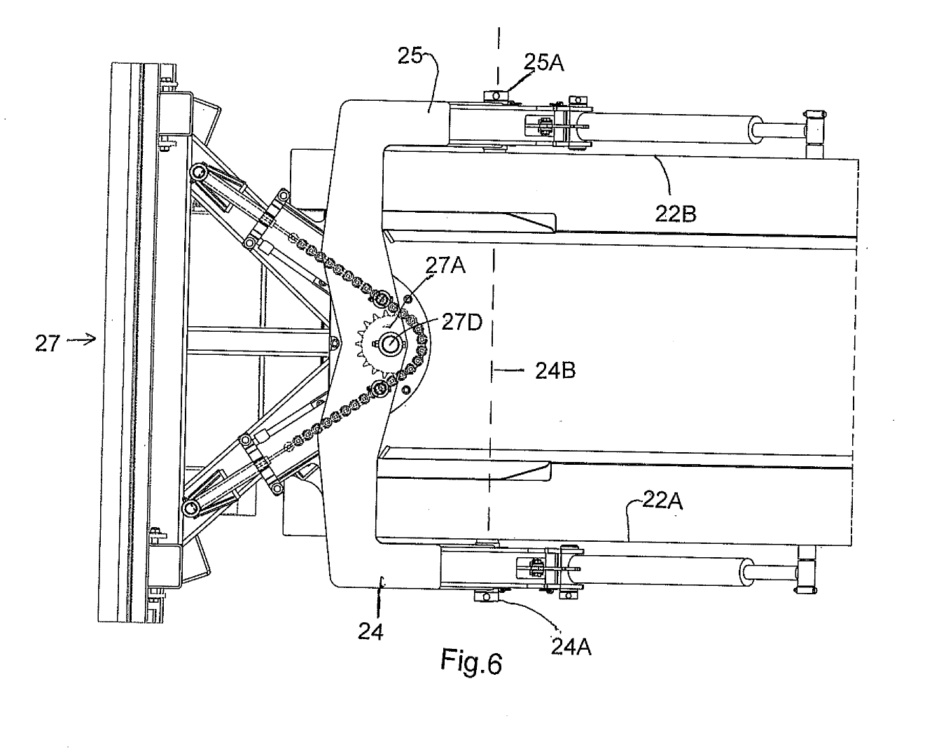

The mounting assembly as shown in FIGS. 3, 4, 5 and 6 23 includes a pair of depending side arms 24 and 25 each arranged on a respective side of the rectangular frame 22 and each coupled to the respective side 22A, 22B of the frame 22 at a pivot 24A, 25A to provide a swivel support about a horizontal axis 24B. Movement of the frame 22 relative to the pivot axis 24B is effected by a cylinder 24C acting between a bushing 24E on the side 24A of the frame and a lever position 24D on the arm 24 at a position spaced from the axis 24B. The cylinder is arranged to tilt the frame 22 between the positions shown in FIG. 1 where the frame stands vertically upwardly between the arms 24, 25, the position shown in FIG. 3 where the frame is inclined upwardly and outwardly and to the lowermost position where the frame is close to horizontal. In order to allow the frame to move to the raise position, the arm 24 is supported at a position extending rearwardly on bars 24F and 24G and symmetrically the arm 25 is mounted on bars 25F and 25G. The bar 24F connects to the bar 25F by a cross bar 24H and the bar 24G connects to the bar 25G by a cross bar 25H

The mounting assembly further includes a support bracket 27 attached to the rear wall 14 of the container. The support bracket 27 carries a central hub 27A defined by a pair of triangular braces 27B and 27C pivotally attached respectively to the cross beams 24H and 25H which carry the side arms 24 and 25. This pivotal connection between the bracket 27 and the cross bars 24H, 25H provides a swivel about an upright axis 27D. Actuation of the movement about the axis 27D is effected by a pair of cylinders 27F and 27G which pull a chain 27H back and froth to drive a sprocket 27J attached at the hub 27A.

The mounting thus provides a first swivel support for providing pivotal movement side to side of the support frame about the generally upstanding axis 27B and a second swivel support for providing pivotal movement up and down of the support frame about a generally horizontal axis 24B.

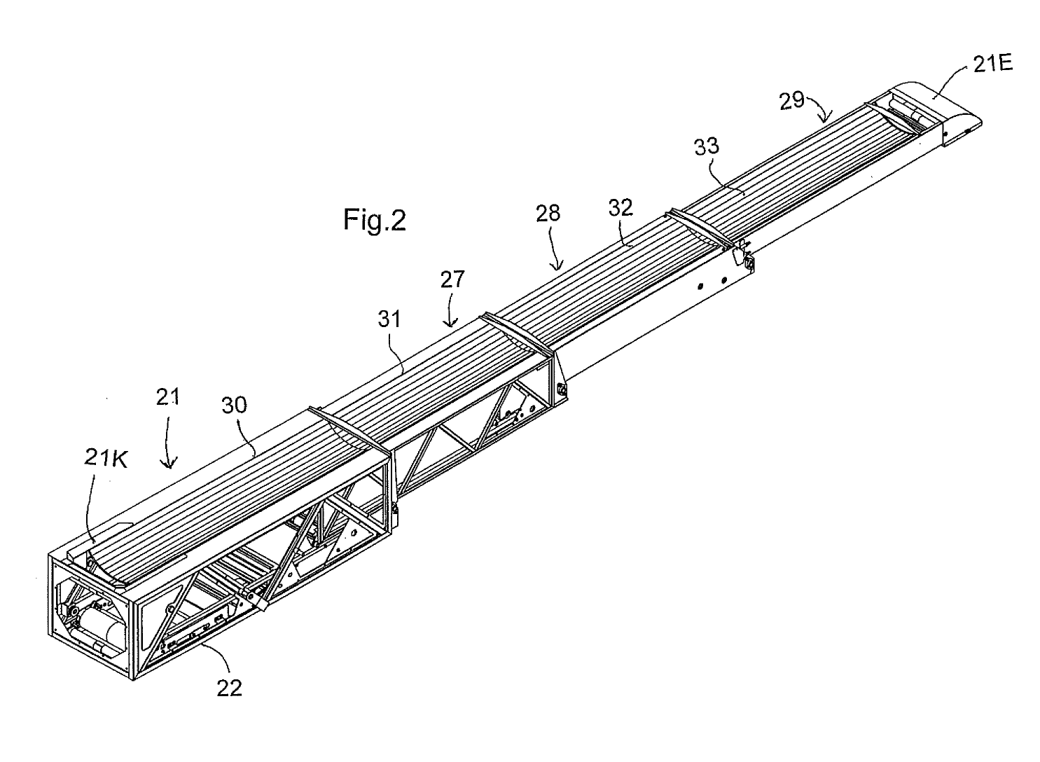

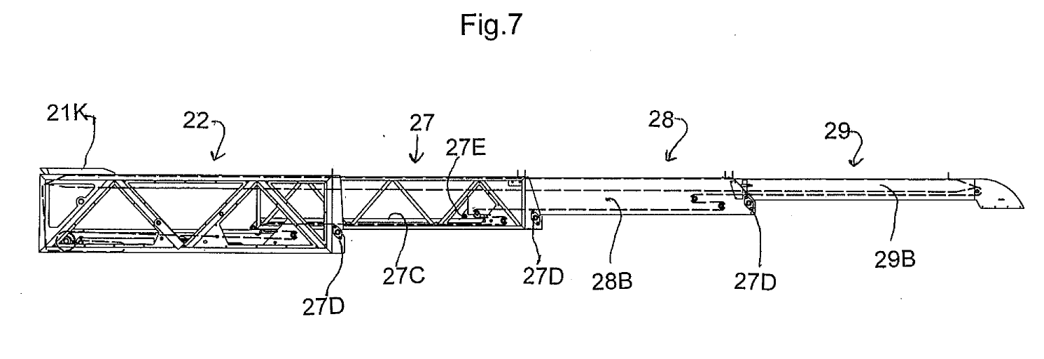

The discharge conveyor 21 as best shown in FIGS. 2, 7,8, 12 and 13 includes a single belt 21A which extends around a bottom drive roller 21B and a top idler roller 21C so that in the extended position of the discharge conveyor the belt extends from the bottom feed end 21D to a top discharge spout 21E.

Within the frame 22 is provided a plurality of conveyor belt support sections 27, 28 and 29 each having one or more support rollers 27A, 28A for guiding the belt 21A. The conveyor belt support sections 27, 28 and 29 are mounted on the frame 22 such that they can be telescoped from a retracted position in which the conveyor belt support sections 29, 28, 27 and 22 overlie one another in order to an extended position with which the conveyor belt support sections are arranged in an extended row carrying the belt out to the spout 21E.

The belt 21A includes a top run which extends between as a straight line between the bottom drive roller and a top return roller and has a return or bottom run underneath the top run which is arranged to fold in the retracted position so that it zig zags back and forth within the retracted sections and to be unfolded and extended in the extended position. Thus in the extended position the belt provides a single flat top run to carry the material to transport material to an upper end of the extended row and a return run wrapped in zig zag overlapping manner around guide rollers through each section. In the retracted position the length of the overlap portion of the return run of the belt in each section increases to take up the change in length of the supporting frame.

There are four sections each of which has a length of the order of 8 feet so that the reduced length when all retracted is able to stand vertically upwardly along the rear of the container without reaching significantly higher than the container and the length when extended is of the order of 32 feet which is sufficient to reach out to a seeder hopper.

The outer sections 27, 28 and 29 retract inwardly on top of each other to form a stack of the sections with the section within the base frame 22 at the bottom. The frame 22 of the innermost section is substantially rectangular with side walls 22A and 22B and with a top 22C and bottom 22D. The frame is formed by trusses 22E extending back and forth to provide sufficient strength to hold the structure in the required shape and to provide cantilever support for the further sections. The section 27 is also formed of truss members and the sections 28 and 29 have solid side walls 28B and 2913. Each of the sections 22, 27 and 28 includes a track 27C which allows the next outer section to slide inwardly with the outer sections stacked on top of one another in a row within the frame 22. The track 27C includes an end roller 27D which provide the main support to the next section and an opposed end roller 27E which runs along the track.

Thus each of the frames and the sub-frames is generally rectangular in cross-section and includes parallel side walls each of which slides into the next adjacent subframe on the respective track. As best shown in FIG. 2, each of the frame 22 and the sub-frames has a cover panel 30, 31, 32, 33 over the belt within the respective section and the covers each slide underneath the cover of the next adjacent section.

As shown in FIGS. 3 and 9, there is provided a hopper 21K at the bottom of the discharge conveyor at the top of the frame 22 and carried on the frame 22, with the hopper defining walls which converge the material from the chute 20D of the conveyor belt 18.

A latch 33 is operable between the arm 24 and the frame 22 to hold the frame in each of its positions when retracted and deployed to ensure that the frame remains at the required angle without possibility to inadvertently collapse.

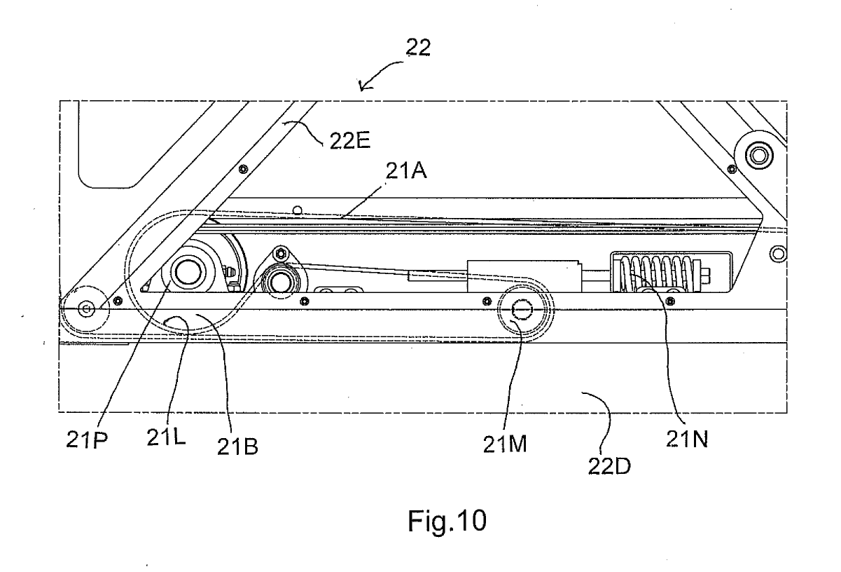

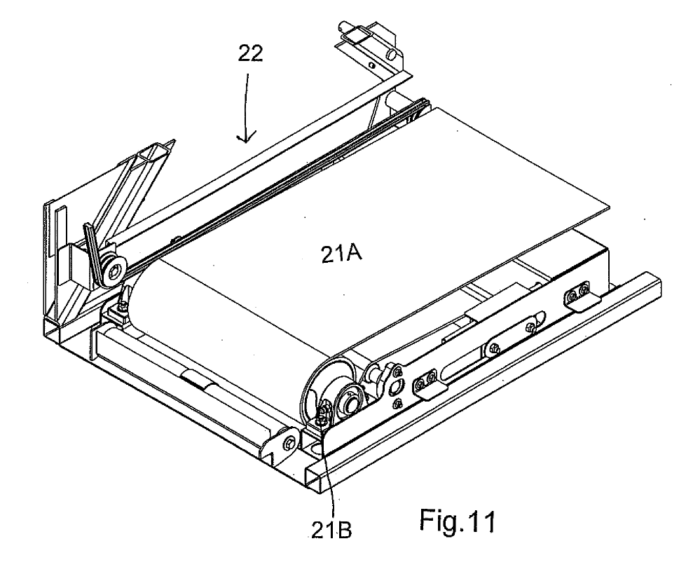

As shown in FIGS. 10 and 11, the belt 21A is driven by the drive roller 21B at the bottom end of the conveyor. The belt 21A is wrapped around a cylindrical surface 21L of the drive roller 21B and extends from the drive roller 21B to an idler tensioning roller 21M carried on a spring tension 21N. The roller 21B has a hydraulic motor 21P which is mounted within and wholly contained within the cylindrical surface 21L. In this way the arrangement is kept simple without the necessity for external drive motors carried on the frame which may interfere with the retracting action of the outer sections.

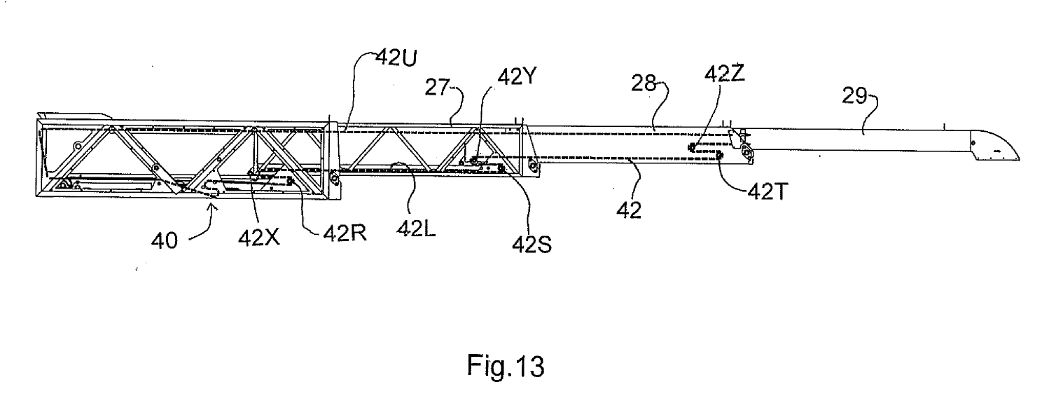

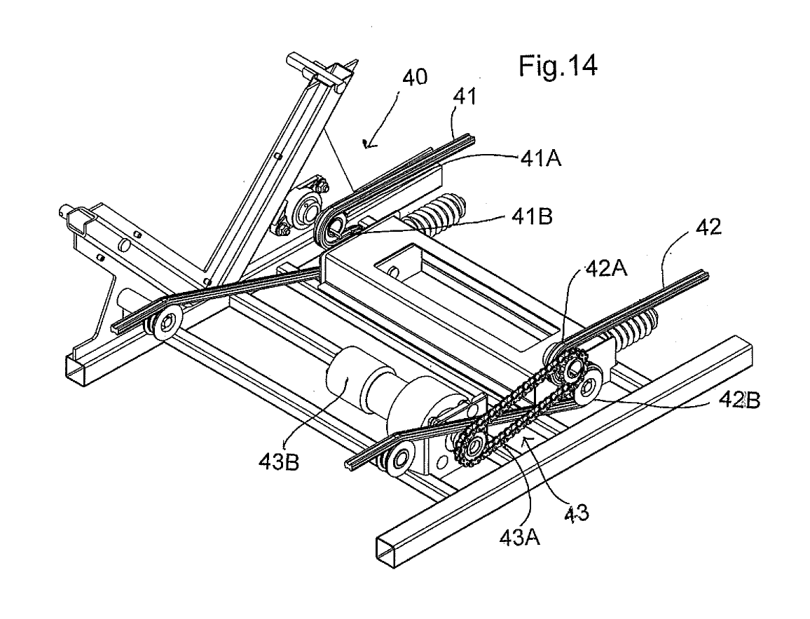

The sections are driven between the extended and retracted positions by a retraction drive arrangement for driving extension and retraction of the conveyor belt support sections. This arrangement is shown generally at 40 in FIGS. 13 and 14 and comprises a pair of chains 41 and 42 on respective sides of the frame 22. Each of these chains is driven along its length by a drive arrangement 43 driving a pair of sprockets 41A and 42A through a chain drive 43A from a motor 43B. The chains wrap around an idler sprocket 41B and 42B. As best shown in FIG. 13, the chains 42 and 41 extend in serpentine manner around the sections 27, 28 and 29 and is driven along its length to retract each section relative to the next. For this purpose, the chain defines an upper run 42U which extends to the inner end of the section 29 and acts, when the chain is driven to the left at the chain drive 43, to pull in the section 29. At the same time the chain has a lower run 42L which wraps around a first sprockets 42R, 42S and 42T on the sections 22, 27 and 28 which acts to drive the sprockets 42X, 42Y and 42Z to the left acting to pull in the sections 27, 28 and 29 symmetrically at a common rate of movement. It will be appreciated that reversing he action and driving the chain to the right wall act to deploy the sections to the extended positions.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A seed tender comprising:
a container for mounting on a ground transportation vehicle;
the container having a plurality of separate compartments at separate locations along the length of the container, each compartment having a bottom discharge opening with a discharge control mechanism for allowing discharge of material when required;
a conveyor belt extending along the container underneath the discharge openings for receiving the material therefrom and transporting the material to a rear of the container;
and a discharge conveyor for receiving the material from a rear end of the conveyor belt and for conveying the material to a selected location beyond the rear of the container, the discharge conveyor comprising:
a support frame;
a mounting assembly for mounting the support frame on the container and providing a first swivel support for providing pivotal movement side to side of the support frame about a generally upstanding axis and a second swivel support for providing pivotal movement up and down of the support frame about a generally horizontal axis;
a plurality of conveyor belt support sections each having one or more support rollers for guiding the belt;
the conveyor belt support sections being mounted on the frame such that they can be telescoped from a retracted position in which the conveyor belt support sections overlie one another to an extended position with which the conveyor belt support sections are arranged in an extended row;
a belt arranged to fold in the retracted position and to be unfolded and extended in the extended position such that the belt extends along the extended row to transport material to an upper end of the extended row;
and a retraction drive arrangement for driving extension and retraction of the conveyor belt support sections.

2. The seed tender according to claim 1 wherein there are at least three sections.

3. The seed tender according to claim 1 wherein there are four sections.

4. The seed tender according to claim 1 wherein at least one outer section retracts inwardly on top of at least one inner section to form a stack of the sections.

5. The seed tender according to claim 1 wherein the frame is substantially rectangular with the sections stacked on top of one another in a row within the frame.

6. The seed tender according to claim 1 wherein the mounting assembly includes a pair of depending side arms each arranged on a respective side of the frame and each coupled to the respective side to provide the second swivel support.

7. The seed tender according to claim 6 wherein the mounting assembly includes a support bracket for attachment to the container, the support bracket including the first swivel support for carrying a central hub attached to the side arms.

8. The seed tender according to claim 1 wherein a first section is mounted in fixed position within the frame and each of the further sections includes a respective sub-frame which slides inside the frame so that each sub-frame slides inside a next adjacent sub-frame.

9. The seed tender according to claim 1 wherein each of the frames and the sub-frames is generally rectangular in cross-section and includes parallel side walls.

10. The seed tender according to claim 1 wherein each or the frame and the sub-frames has a cover which slides underneath the cover of the next adjacent section.

11. The seed tender according to claim 1 wherein there is provided a hopper at the bottom of the discharge conveyor and carried on the frame.

12. The seed tender according to claim 1 wherein the conveyor belt has a rear end thereof which is at a fixed relative to the container and wherein there is provided a discharge nozzle at the end of the conveyor belt and arranged to direct material onto the bottom of the discharge conveyor, the nozzle being pivotally adjustable in a direction longitudinally of the discharge conveyor.

13. The seed tender according to claim 1 wherein the belt is driven by a drive roller at one end of the conveyor with the belt wrapped around a cylindrical surface of the drive roller and wherein the drive roller has a hydraulic motor which mounted within the cylindrical surface.

14. The seed tender according to claim 1 wherein the retraction drive arrangement comprises a chain extending in serpentine manner around the sections and driven along its length to retract each section relative to the next.

15. The seed tender according to claim 1 wherein the container has at least four compartments.

16. The seed tender according to claim 1 wherein the container has a base arranged to sit on a frame of a separate trailer.

17. The seed tender according to claim 16 wherein the mounting assembly is arranged to mount the discharge conveyor on the container separate from the trailer.

18. The seed tender according to claim 17 wherein the frame and the sections therein is arranged to stand substantially vertically along a rear of the container in a transport position thereof.

19. The seed tender according to claim 18 wherein the frame and the sections therein have a height in the transport position which is not substantially greater than that of the container.

20. A seed tender comprising:
a container for mounting on a ground transportation vehicle;
the container having a plurality of separate compartments at separate locations along the length of the container, each compartment having a bottom discharge opening with a discharge control mechanism for allowing discharge of material when required;
a conveyor belt extending along the container underneath the discharge openings for receiving the material therefrom and transporting the material to a rear of the container;
and a discharge conveyor for receiving the material from a rear end of the conveyor belt and for conveying the material to a selected location beyond the rear of the container, the discharge conveyor comprising a belt and a plurality of guide rollers;
wherein the belt is driven by a drive roller at one end of the conveyor with the belt wrapped around a cylindrical surface of the drive roller and wherein the drive roller has a hydraulic motor which mounted within the cylindrical surface.
